(19) United States
(12) Patent Application Publication
(10) Pub. No.: US 2026/0244293 A1
(43) Pub. Date: Aug. 20, 2026

(54) CONDUCTIVE WIRE-BASED CAPACITIVE INPUT INTERFACE WITH TACTILE ACCESSIBILITY IN ELECTRONIC MUSIC DEVICES

(71) Applicant: Derek Song, Chicago, IL (US)

(72) Inventor: Derek Song, Chicago, IL (US)

(21) Appl. No.: 19/320,676

(22) Filed: Sep. 5, 2025

Related U.S. Application Data
(60) Provisional application No. 63/834,088, filed on Feb. 18, 2025.

(51) Int. Cl. G06F 3/041

(52) U.S. Cl. CPC G06F 3/0416

(57) ABSTRACT

An input interface for an electronic musical device provides an accessible tactile control mechanism for sound synthesis. The input interface utilizes conductive wires formed into raised tactile shapes electrically connected to capacitive sensing electrodes to form a capacitive input interface. When integrated into an electronic musical device, the capacitive input interface provides various tactile, accessible control mechanisms for the synthesis for musical sounds.

### CROSS-REFERENCE TO RELATED PATENT APPLICATIONS

This application claims the benefit of and priority to U.S. Provisional Patent Application No. 63/834,088, filed Feb. 18, 2025, the entire disclosure of which is incorporated by reference herein.

### BACKGROUND

The present disclosure relates generally to the field of electronic devices. According to some implementations, the disclosure relates to electronic music devices such as synthesizers, samplers, sequencers, and controllers. Each electronic music device utilizes various functions to generate musical sounds. To utilize the musical device functions, they often utilize user interaction with one or more components.

Electronic music devices are often not intuitive for use and typically do not provide tactile feedback to the user. The components used to interface with the electronic music device contribute to these deficiencies causing the devices to be less accessible. For example, physical actuators like push buttons and faders provide immediate feedback but are limited in terms of functional flexibility or are too large to create a portable electronic music device, limiting musical production. In particular, push buttons are compact and can have many arrangements but are not ideal to provide position or pressure information. Faders are available in many sizes but are often reserved for specific functions like volume control. Capacitive touch interfaces can detect touch and often position; however, they are typically flat surfaces, lacking immediate feedback provided by physical actuators. All these limitations prevent intuitive and accessible music production with electronic music devices.

### SUMMARY

One embodiment of the disclosure relates to an input interface for an electronic musical device. The input interface includes a printed circuit board and conductive wire formed into a raised tactile shape. The printed circuit board includes at least one capacitive sensing electrode. The conductive wire is mounted to the printed circuit board and is electrically coupled to the at least one capacitive sensing electrode. The conductive wire is configured to function as a capacitive input element for detecting user touch and providing tactile feedback.

In some embodiments, the conductive wire is shaped into a symbol, character, or ergonomic contour corresponding to a music function.

In some embodiments, the conductive wires protrudes though an aperture in an enclosure of the electronic musical device to provide tactile accessibility.

In some embodiments, the input interface includes a light-emitting diode (LED) mounted beneath the conductive to provide visual feedback.

In some embodiments, the input interface includes a plurality of conductive wires electrically coupled to a plurality of electrodes. The plurality of conductive wires form a multi-functional control interface. The multi-functional control interface includes a plurality of musical functions corresponding to the raised tactile shape of the plurality of conductive wires.

In some embodiments, the printed circuit board includes at least one capacitive-sensing integrated circuit electrically coupled to the at least one capacitive sensing electrode.

Another embodiment related to an electronic musical device. The electronic musical devices including a housing, an input interface and a processing circuit electrically coupled to the input interface. The input interface includes a printed circuit board comprising at least one electrode and a conductive wire formed into a raised tactile shape, mounted to the printed circuit board. The conductive wire is electrically coupled to the at least one electrode and configured to function as a capacitive input element for detecting user touch and provide tactile feedback. The processing circuit is configured to interpret capacitive signals from the conductive wire and generate musical control signals responsive to user interaction.

In some embodiments, the processing circuit is configured to map capacitive input to musical parameters including note velocity, pitch bend, or filter modulation.

In some embodiments, the housing includes multiple apertures though which respective conductive wires protrude, and each wire is shaped to indicate a distinct musical function.

In some embodiments, the electronic musical device includes a vibration actuator configured to provide haptic feedback correlated to a synthesis parameter.

In some embodiments, the processing circuit includes at least one capacitive-sensing integrated circuit configured to determine control signals based on sensed capacitance from a user interaction with the input interface and a processor electrically coupled to the at least one capacitive sensing integrated circuit, configured to generate musical control signals based on the control signals. The capacitive-sensing integrated circuit transmit control signals to the processor.

In some embodiments, the processing circuit is configured to determine a location and intensity of a user interaction with the input interface and generate a plurality of musical control signals. The plurality of musical const signals vary based on the location and intensity of the user interaction with the input interface.

In some embodiments, the input interface includes a plurality of conductive wires electrically coupled to a plurality of electrodes. The plurality of conductive wires form a multi-function control interface, and the multi-functional control interface includes a plurality of musical functions corresponding to the raised tactile shape of the plurality of conductive wires.

In some embodiments, the multi-functional control interface includes a first plurality of conductive wires configured to mimic a function of keys of a keyboard and a second plurality of conductive wires configured to provide control to the function of the first plurality of conductive wires.

In some embodiments, the first plurality of conductive wires musically functions as keys on the keyboard and the second plurality of conductive wires changes the function of the first plurality of conductive wires from a first set of keys of the keyboard to a second set of keys of the keyboard.

Another embodiment relates to a method of input interface. The method includes forming a conductive wire into a predetermined tactile shape, securing at least one end of the conductive wire to a printed circuit board (PCB) such that the conductive wire is electrically coupled to a capacitive sensing electrode, and routing the conductive wire through and aperture in an enclosure of an electronic musical device such that the conductive wire protrudes from an exterior surface of the enclosure.

In some embodiments, the method includes mounting a light-emitting diode (LED) beneath the conductive wire to provide visual feedback.

In some embodiments, the method includes shaping the conducive wires using automated wire-bending equipment into a two-dimensional or three-dimensional form.

In some embodiments, the method includes selecting the conductive wire from stainless steel or aluminum and treating the conductive wire to be solderable.

In some embodiments, the method includes arranging a printed circuit board layout to position service-prone components on a side opposite of an interior portion of the enclosure to facilitate repair.

### BRIEF DESCRIPTION OF THE DRAWINGS

FIG. 1A is a drawing illustrating a component view of a single wire capacitive input interface.

FIG. 1B is a drawing illustrating an installed view of a single wire capacitive input interface.

FIG. 2 is a drawing illustrating a component view of a multi-wire capacitive input interface.

FIG. 3 is a drawing of a cross section of an electronic music device utilizing a single wire capacitive input interface.

FIG. 4A is a drawing illustrating an arrangement of a multi-wire capacitive input interface that behaves as a keyboard, or slider, or similar musical device.

FIG. 4B is a table illustrating note and function configurations for the arrangement shown in FIG. 4A.

FIG. 5 is a drawing illustrating an arrangement of a compact multi-wire capacitive input interface that behaves as a compact two-axis position and pressure sensor.

FIG. 6 is a drawing illustrating a multi-functional arrangement of a multi-wire capacitive input interface that behaves as a multi-functional note grid.

FIG. 7 is a drawing illustrating an electronic music device implementing a multi-functional multi-wire capacitive input interface.

FIG. 8A is a drawing illustrating a view of an electronic music device with a complex enclosure shape implementing a multi-wire capacitive input interface.

FIG. 8B is a drawing illustrating a secondary view of an electronic music device with a complex enclosure shape implementing a multi-wire capacitive input interface.

FIG. 9A is a drawing illustrating a top view of an electronic music device implementing a multi-wire capacitive input interface with complex 3D shaped wire.

FIG. 9B is a drawing illustrating an overhead angled view of an electronic music device wit implementing a multi-wire capacitive input interface with complex 3D shaped wire.

FIG. 9C is a drawing illustrating a front view of an electronic music device implementing a multi-wire capacitive input interface with complex 3D shaped wire.

FIG. 9D is a drawing illustrating a side view of an electronic music device implementing a multi-wire capacitive input interface with complex 3D shaped wire.

FIG. 10 is a drawing illustrating a portable electronic music device with a guitar shaped enclosure implementing the multi-wire capacitive input interface depicted in FIG. 6.

FIG. 11 is a flow diagram depicting a method for making an electronic device using a wire-based capacitive input interface.

### DETAILED DESCRIPTION

Referring generally to the FIGURES, a wire-based capacitive input interface in accordance with the present disclosure may be used as a control interface for electronic devices, including electronic musical devices. The wire-based capacitive input interface provides a tactile interface, which may provide a mechanism for various controls and operations identifiable by the user though interaction with the interface.

A wire-based capacitive input interface may provide more intuitive and accessible control of an electronic device relative to existing electronic device interfaces solely utilizing various input components, such as buttons, switches, encoders, potometers, faders, proximity sensors, piezo-transducers, or some variation of resistive or capacitive sensors, such as a touch screen display. Existing electronic device input interfaces utilize device components that may limit variability in control and operation or may not be tactile and accessible. A wire-based capacitive input interface may provide features including variable control, a tactile interface, and accessibility that may provide more intuitive and creative control of electronic devices relative to existing electronic device interfaces.

In some embodiments, the wire-based capacitive input interface may be integrated with an electronic musical device, to control the production of musical sounds. When integrated with an electronic musical device the wire-based capacitive input interface may provide a tactile interface where interface control functions may be identified by the shape or form of the wire surface. The tactile surface may provide an accessible and intuitive surface for musical sound production.

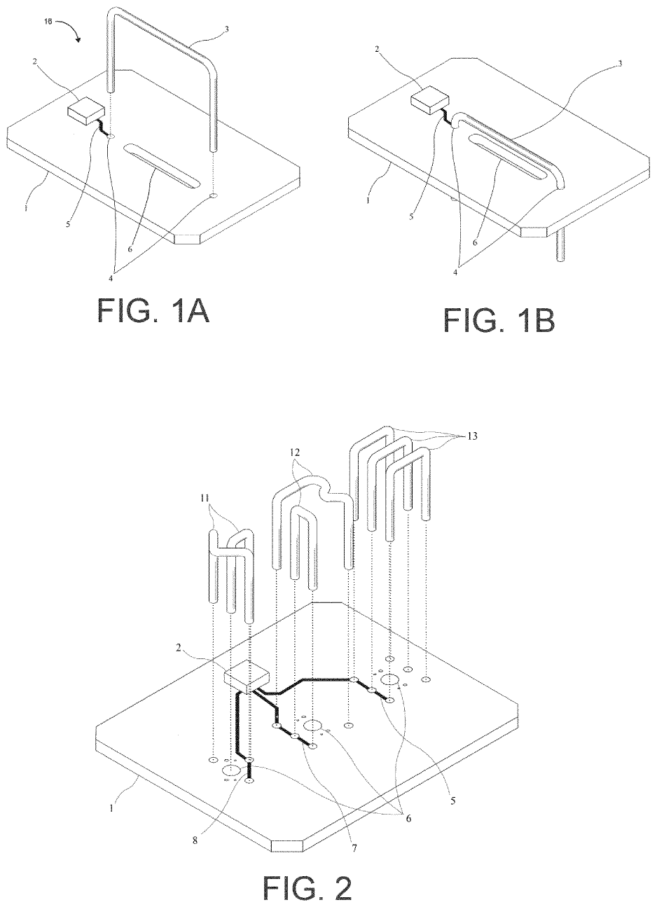

Referring now to FIG. 1A, a component view of a single wire capacitive input interface 16 is shown. The single wire capacitive input interface 16 includes a printed circuit board (PCB) 1 with a conductive mounting mechanism, for example one or more solderable through-holes 4. At least one solderable through-hole 4 is connected to a capacitive-sensing electrode 5 that serves as an input to a capacitive-sensing integrated circuit 2, including but not limited to a capacitive touch controller. A piece of conductive wire 3 is formed into a raised tactile two-dimensional or three-dimensional shape so that both ends may be inserted through the solderable through-holes 4 on the printed circuit board (PCB) 1 and the raised tactile shape of the conductive wire 3 may provide the user with specific tactile feedback when interacted with. The conductive wire 3 may include a wire formed from a conductive metal or another fabricated conductive material, which functions similarly to a conductive wire 3. The conductive wire 3 may be made from a variety of conductive metals, such as a durable corrosion resistant material such as aluminum or stainless steel. The printed circuit board (PCB) 1 may also include a slot or hole 6 positioned under the conductive wire 3, allowing light from a light-emitting diode (LED) to pass though.

FIG. 1B depicts a single wire capacitive input interface 16 as depicted in FIG. 1A is shown with components installed on the printed circuit board (PCB) 1. The formed conductive wire 3 is inserted though the through-holes 4 on the printed circuit board (PCB) 1 and fixed in place so that the conductive wire 3 is electrically coupled to the through-holes 4 and the raised portion of the conductive wire 3 is fixed in a raised position above the printed circuit board (PCB) 1. The conductive wire 3 may be fixed in place using solder. In some implementations, the conductive wire 3 may also be treated for solderability to ensure that the conductive wire 3 remains electrically coupled with the conductive mounting mechanism or through-holes 4 when the interface is used. At least one of the through-holes 4 is electrically connected to the capacitive-sensing electrode 5 making the conductive wire 3 capacitive. The second end of the conductive wire 3 may be terminated to a through-hole 4. The through-hole 4 may be connected to the same capacitive-sensing electrode 5 so the second end of the conductive wire 3 is connected to the capacitive-sensing electrode 5. The through-hole 4 may be connected or unconnected to ground on the printed circuit board (PCB) 1 and unconnected from the capacitive-sensing electrode 5. The formed conductive wire 3 is configured to function as a capacitive input element for detecting user interaction. The ends of the conductive wire 3 may extend below the printed circuit board (PCB) 1. The raised portion of the conductive wire 3 is positioned so that a person can interact with the conductive wire 3 providing a mechanism for tactile interaction with the capacitive input interface.

Alternatively, the conductive wire 3 may be mounted using surface mount pads. When mounted using surface mount pads, the conductive wire 3 still has a raised portion providing a mechanism for tactile interaction with the single wire capacitive input interface. The second end of the conductive wire 3 may additionally be unconnected from printed circuit board (PCB) 1. If the second end of the conductive wire 3 is unconnected from the printed circuit board (PCB) 1, it may be covered by an enclosure or covered by another method.

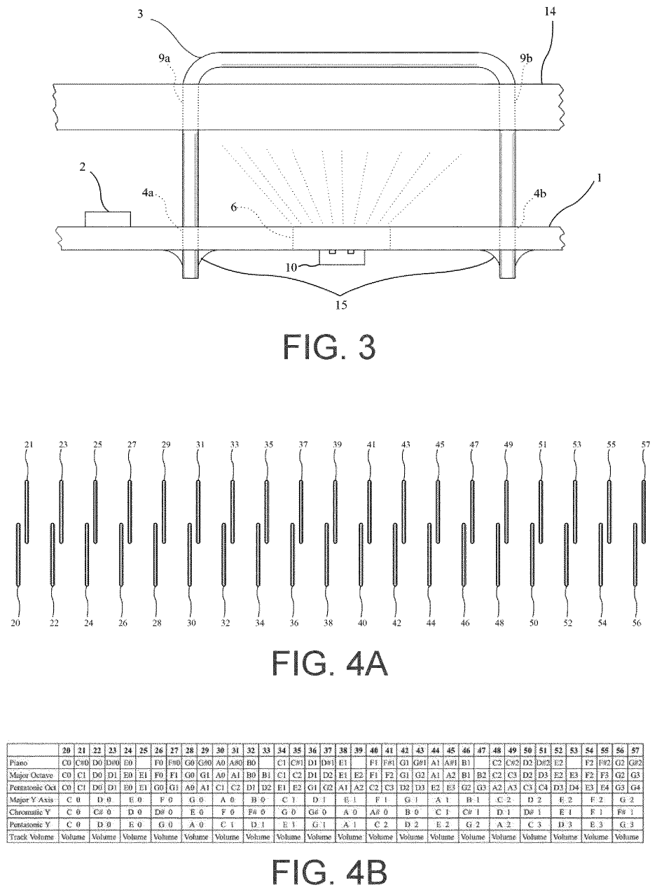

Referring to FIG. 2, a multi-wire capacitive input interface is shown. A multi-wire capacitive input interface includes a printed circuit board (PCB) 1 and at least one set of conductive wires 11-13. Each set of conductive wires 11-13 includes at least one conductive wire. The printed circuit board (PCB) 1 includes at least one conductive mounting mechanism for each set of conductive wires 11-13 and a capacitive-sensing electrode 5, 7, 8 for each set of conductive wires 11-13, electrically coupled to the conductive mounting mechanisms corresponding to a set of conductive wires 11-13. The capacitive-sensing electrodes 5, 7, 8 serve as inputs to a capacitive-sensing integrated circuit 2, including but not limited to a capacitive touch controller.

The multi-wire based capacitive input interface includes at least one set of conductive wires 11-13 containing more than one piece of conductive wire formed into a raised tactile shape. In some implementations, the shape may depict a symbol, character, or ergonomic contour identifiable to the user. For example, the first set of conductive wires 11 could be formed into the shape of an arrow, utilizing two pieces of conductive wire. Additionally, a set of conductive wires 12 could be formed into a character such as an “R”, or other shapes and symbols. The set of conductive wire 11 shaped as an arrow has two ends terminated to a mounting mechanism electrically coupled to a capacitive-sensing electrode 8, one end terminated to a mounting mechanism not coupled to any capacitive-sensing electrode 5, 7, 8. The set of conductive wires 12 shaped as an “R” has three ends terminated to a mounting mechanism electrically coupled to a capacitive-sensing electrode 7, and one end terminated to a mounting mechanism not electrically coupled to any capacitive-sensing electrode 5, 7, 8. The set of conductive wires 13 shaped as three parallel lines has three ends terminated to a mounting mechanism electrically coupled to a capacitive-sensing electrode 5, and three ends terminated to a mounting mechanism not electrically coupled to any capacitive-sensing electrode 5, 7, 8. The sets of conductive wires 11-13 electrically coupled to a capacitive sensing electrode creates a capacitive input interface, where a user interaction with one or more sets of conductive wires 11-13 may be sensed based on an induced capacitive change. In some embodiments, to ensure accuracy of capacitance readings and limit excessive electrode inputs, a single set of conductive wires 11-13 may be electrically coupled to a single capacitive-sensing electrode 5, 7, 8. Utilizing multiple electrodes on a single wire set, where each of the wires are already electrically connected to another capacitive-sensing electrode 5, 7, 8, may trigger false capacitance readings.

A user may interact with a conductive wire 3 or sets of conductive wires 11-13 through touching the wires to induce a capacitive change. Interacting with or touching a conductive wire 3 with another conductive item, such as a user touching the wire with a finger, changes the electrical field of the wire, inducing a change in the capacitance. The change in capacitance may vary based on the pressure applied, length of interaction, and location on the conductive wire 3 or set of conductive wires 11-13. The capacitance may also change based on movement when interacting or touching the conductive wire 3 or sets of conductive wires 11-13, such as moving a finger across a conductive wire 3. The change in capacitance may be recognized by the capacitive-sensing electrode 5, 7, 8 and the capacitive-sensing electrode 5, 7, 8 may transmit a capacitive signal to a processing circuit to interpret the capacitive signal as touch or interaction.

The multi-wire capacitive input interface may include a capacitive-sensing integrated circuit 2. The capacitive-sensing integrated circuit 2 may be included in a processing circuit. The processing circuit may also include a processor or processing circuit. The capacitive-sensing integrated circuit 2 may generate control signals based on the sensed capacitive change or capacitive signals induced by user interaction with the capacitive input interface. The control signals may be used by the processing component of the processing circuit in an electronic music device to generate musical sounds based on the user interaction with the input interface. The sensed capacitance may provide information based on the pressure used when touching the input interface, allowing a variety of control signal to be produced by the capacitive sensing integrated circuit. When integrated into an electronic music device each set of conductive wires 11-13 on the input interface correspond to a distinct musical function of the electronic musical device based on the tactile shape of the set of conductive wires 11-13, providing a multi-functional interface. The functions of the music device may include generating musical sounds including notes, beats, vocals, or other sounds consistent with music production, recoding a sequence of musical sounds, playing back recorded musical sound sequences, altering the function of other formed wires or sets of formed wires, or altering parameter of synthesized or recorded musical sounds. When altering the function of other formed conductive wires or sets of formed conductive wires, the change may include changing the octave of the musical sound generated, changing the musical instrument corresponding to the musical sound generated, or altering the function of the wires to function as a set of wires for a specific set of control functions rather than a single control function for each wire, among other features. Each wire function is configured by the processing component within the processing circuit. The processing component is configured map capacitive inputs to musical parameters and musical sounds through interpreting the control signals generated by the capacitive-sensing integrated circuit 2 based on the function associated with the input conductive wire set and then generating musical control signals that may be used generate a particular musical sound. In some implementations, one or more of the wire functions may be changeable or configurable by the user, such as by an integrated or separate user interface configured to allow the user to reprogram or otherwise manipulate a function implemented by the processing circuit in response to interaction with the wires.

Referring to FIG. 3, a cross section of an electronic music device utilizing a single wire capacitive interface is depicted. The electronic music device includes an enclosure 14 which houses a printed circuit board (PCB) 1. The printed circuit board (PCB) 1 contains mounting mechanisms 4a, 4b to hold a conductive wire 3 or formed conductive material. At least one mounting mechanism 4a is electrically coupled to a capacitive-sensing electrode 5 that serves as an input to a capacitive-sensing electrode 2. The conductive wire 3 is routed through the enclosure 14 via holes 9a, 9b matching the dimensions of the conductive wire 3. The positions of the enclosure holes 9a and 9b correspond to the mounting mechanisms 4a and 4b. The conductive wire 3 is terminated to the mounting mechanisms 4a and 4b and secured though a solder joint 15. The conductive wire 3 is routed so that the conductive wire 3 is raised above the level of the enclosure 14 so that a person can interact with the conductive wire 3 providing a mechanism for tactile interaction with the single wire capacitive input interface.

The printed circuit board (PCB) 1 can additionally contain a light-emitting diode (LED) 10 mounted below the conductive wire 3. The light-emitting diode (LED) 10 may be mounted to the top of the printed circuit board (PCB) 1 or (e.g., in the case the space is limited or if another mounting location is desired), the light-emitting diode (LED) may be reverse-mounted to the other side of the printed circuit board (PCB) 1. In the case that a light-emitting diode (LED) 10 is reverse-mounted, the printed circuit board (PCB) 1 may have a hole 6 (e.g., opening, light pipe or window, etc.) corresponding to the location of the light-emitting diode (LED) 10 allowing light though the printed circuit board (PCB) 1. The enclosure 14 may also be constructed from a translucent or transparent material to allow the light from the mounted light-emitting diode (LED) 10 to be visible to the user. The light emitting diode (LED) 10 may be used to provide visual feedback based on the functionality of the electronic music device. The light-emitting diode (LED) 10 may signal to the user what the current function of a conductive wire set is. The light-emitting diode (LED) 10 may additionally or alternatively be used to communicate when an interaction from a user is sensed, or when a particular wire function is active.

The cross section of an electronic music device as depicted in FIG. 3 can similarly utilize a multi-wire capacitive interface, utilizing multiple arrangements or groupings of the conductive wires 3. In the case where multiple conductive wires 3, or multiple conductive wire sets are utilized, the enclosure 14 may have additional enclosure holes 9a and 9b to provide apertures for the various wires to be routed thought. Each enclosure hole 9a and 9b may still correspond to various mounting mechanisms 4a and 4b, such that each conductive wire 3 may be electrically coupled to a capacitive-sensing electrode 5 and be accessible for user interactions on the exterior of the enclosure 14. Various arrangements of the multi-wire capacitive interface can be utilized to provide a device interface that is musically expressive using various capacitive sensing techniques. The capacitive-sensing electrodes 5 can detect variable touch information through the variable conductivity of a human finger touching a conductive wire 3, measured in real time using a capacitive-sensing integrated circuit 2 or microcontroller. Through the interpretation of various sensed values, each formed conductive wire 3 may trigger a musical sound, including but not limited to a note, with variable velocity or loudness. Additionally, each conductive wire 3 may control any variable sound parameter of the corresponding musical sound played over time, including but not limited to volume, pitch, filter modulation, pitch bend, or timbre. The formed conductive wire 3 additionally provides a tactile surface that flat capacitive surfaces cannot.

FIG. 4A depicts a multi-wire capacitive wire interface arrangement. This arrangement mimics a keyboard, piano, fader board, or other similar musical/sound devices. The multi-wire capacitive wire interface arrangement contains multiple conductive wires 20-57 each connected to its own separate capacitive-sensing electrode 5. This configuration contains two sets of conductive wires, the higher set corresponds to the even numbered conductive wires 20-57 and lower set corresponds to the odd numbered conductive wires 20-57. An arrangement of two sets of conductive wires as depicted in FIG. 4A may be configured differently depending on the desired musical function and desired sound production. The arrangement in FIG. 4A may include configurations where each wire functions individually, or where a higher wire functions collectively with a corresponding lower wire and the lower wire functions collectively with a corresponding higher wire. FIG. 4B depicts a table outlining various functional configurations for the arrangement depicted in FIG. 4A. Each row of the table determines a functional configuration, and each column identifies a wire corresponding to FIG. 4A and the result of interacting with a particular wire or set of wires. The configurations depicted in FIG. 4B can be defined as configuration with single wire controls such as the configurations depicted in the piano, major octave, and pentatonic octave rows or paired/multi-wire controls such as the configurations depicted in the Major Y Axis, Chromatic Y, Pentatonic Y and Track Volume rows.

The wire configuration can be configured to utilize each of the conductive wires 20-57 as single input, allowing each conductive wire 20-57 to be utilized to generate a different musical sound. The Piano row of the table in FIG. 4B depicts a wire configuration corresponding to the keys on a keyboard or piano. Each wire in the configuration corresponds to a single key which through user interaction can generate musical sounds together or individually, similar to playing keys on a piano or keyboard. In the piano configuration, the lower conductive wires correspond to the white keys on a piano or keyboard and the higher conductive wires correspond to the black keys. In positions corresponding to areas on a keyboard or piano where there are no black keys between the white keys, the higher wire between the two conductive wires corresponding to white keys, does not have a corresponding black key, and is therefore turned off, for example conductive wires 25 and 33 do not have a corresponding note in the table and would be turned off. When a wire is turned off, any interaction with the wire while in the specific configuration would not produce musical sound. The piano configuration not only corresponds to the configuration depicted in the table, but also configurations shifted to different octaves.

The Major Octave row of the table depicts a 7-note octave configuration corresponding to what is considered a major octave in music production and music theory. This configuration comprises a set of wire pairs where each wire pair corresponds to a note in the octave. Each wire pair comprises a lower wire and higher wire, where the lower wire corresponds to a specific note one octave lower than the higher wire, for example conductive wires 20 and 21 are a wire pair and conductive wire 20 corresponds to note C0 and conductive wire 21 corresponds to C1. Each of the lower wires are subsequent notes in the major octave scale in increasing order starting at conductive wire 20 and ending at conductive wire 56. Each of the higher wires correspond to subsequent notes in the major octave scale in increasing order starting at conductive wire 21 and ending at conductive wire 57, and the notes corresponding to the higher wires start one octave above the lower wires. The Pentatonic Octave row depicts a 5-note octave configuration. The specific configuration of the wires and the corresponding notes are similar to that of the Major Octave configuration with five notes rather than seven. The major octave configuration and pentatonic octave configuration can correspond to any major or pentatonic octave and are not limited to the octaves depicted in FIG. 4B. Each wire in these configurations create a corresponding musical sound though user interaction. Each wire can be interacted with individually or together to generate one or more musical sounds at the same time.

The wire arrangement depicted in FIG. 4A can additionally or alternatively be configured to use two wires in combination to control the musical sound generated. The Major Y Axis row of the table depicted in FIG. 4B is one such configuration utilizing two wires in combination to control the musical sound generated. The Major Y Axis configuration assigns a note from a Major Octave to a vertical pair of wires, where both wires play the same note. Each wire is connected to its own capacitive-sensing electrode, allowing the location of user interaction to be determined between the two wires. The ability to sense the location of user interaction on the wires, allows the configuration to not only control the musical sound generated based on the intensity of the interaction, but also the location of the interaction. For example, a user may fade a note or sound in by sliding their finger across the surface of the wires from the bottom of the wire to the top of the wire, set the volume of a note or sound by interacting with the wires at various locations, or fade a note or sound out by sliding their finger across the surface of the wires from the top wire down to the bottom wire. The configurations corresponding to the Chromatic Y Axis and Pentatonic Y Axis rows are the same vertically paired wires, configured to utilize user interaction to generate musical sounds based on specific music notes. The Chromatic Y Axis configuration utilizes a chromatic octave, and the Pentatonic Y Axis configuration utilizes a pentatonic octave. The specific octaves used by each configuration can vary based on the desired octave of the electronic music instrument and may additionally or alternatively be controlled by the user.

The Track Volume row of the table is also configured to use two wires in combination as a vertical pair of wires. The track volume configuration utilizes position sensing across the pair of wires to set the volume of a pre-recorded track on the electronic music device. Each vertical pair of wires corresponds to a different track on the electronic musical device. The specific pairs of wires selected to control a specific track varies based on the capabilities of the electronic music device that implements the configuration.

The specific configuration of the wire arrangement depicted in FIG. 4A may be determined by a pre-programmed processing circuit programed with one or more configurations. If the processing circuit is programed with more than one configuration the user may be able to select the configuration using a wire based capacitive input interface or another interface on the electronic music device. Additionally, or alternatively, the processing circuit may be configured to allow the user to program their own configurations allowing the user increased variability and expressiveness with creating musical sounds. The processing component of the processing circuit interprets control signals from a capacitive-sensing integrated circuit 2 and generates a musical control signal based on the received control signal and selected wire configuration of the wire set. The capacitive-sensing integrated circuit 2 transmits a control signal to the processing component based on a sensed capacitance change or capacitive signals induced by user interactions with the capacitive input interface. The conductive wire arrangement depicted in FIG. 4A may additionally be extended or reduced by altering the number of capacitive wires and capacitive sensing electrode utilized in the input interface to fit a desired musical device form-factor.

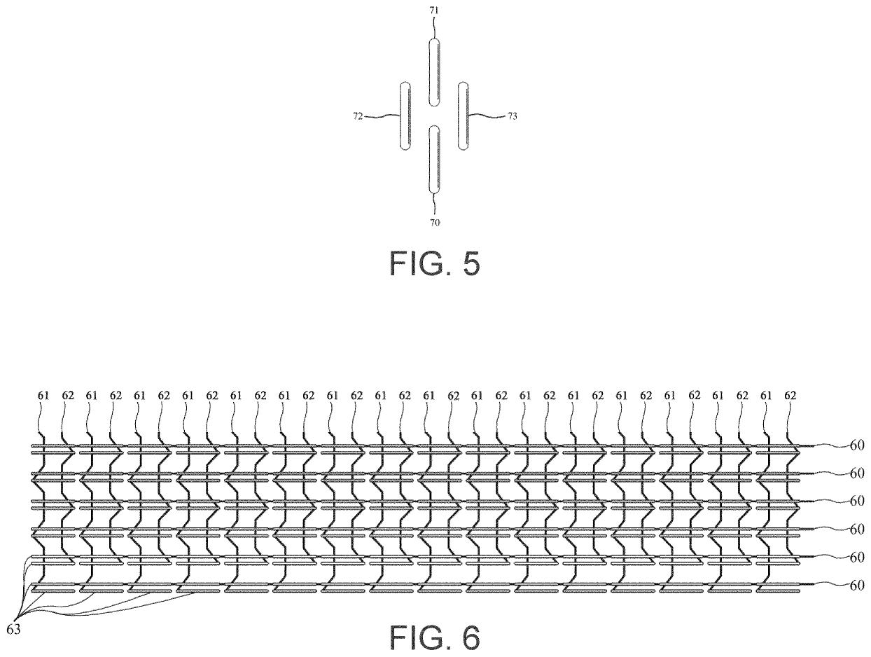

In some embodiments it is desirable to control three real-time sound parameters independently within a small area. FIG. 5 depicts a compact multi-wire capacitive interface wire arrangement configurable to control multiple real-time sound parameters. The arrangement comprises four wires arranged a compact diamond cluster configuration where all conductive wires 70-73 are oriented in the same direction. Conducive wire 70 is positioned as the bottom wire, conductive wire 71 is positioned as the top wire, conductive wire 72 is positioned as the left wire, and conductive wire 73 is positioned as the right wire. Each of the wires in this arrangement may be configured with a single function control corresponding to a real-time sound parameter, allowing the user to interact with each wire individually to produce various sound effects. Additionally, or alternatively, the arrangement may be configured to act as a three-dimensional sensor with all the wires configured for one function. The arrangement can be configured to detect x-axis position, y-position, and intensity based on the sensed capacitance from user interaction. The XY position and intensity configuration may be used as an encoder to determine various real-time sound parameters or controls for the electronic musical instrument.

FIG. 6 depicts an additional multi-wire capacitive wire interface arrangement. This arrangement provides the user the ability to independently bend polyphonic notes organized in a grid, while efficiently utilizing available capacitive-sensing electrodes. The arrangement comprises conductive wires 63 arranged in pairs electrically coupled to capacitive-sensing electrodes 60-62, where capacitive-sensing electrodes 61 and 62 are oriented vertically and capacitive-sensing electrodes 60 are oriented horizontally. The conductive wires 63 are oriented horizontally in pairs. Each pair comprises a first wire positioned above a second wire with a small space between. The configuration places wires pairs in a grid with at least two rows and at least two columns. Each column comprises at least one set of wires comprising a first pair of wires and second pair of wires, and a pair of capacitive-sensing electrodes 61 and 62. The pair of capacitive-sensing electrodes may include a first capacitive-sensing electrode 61 and a second capacitive-sensing electrode 62. The first capacitive sensing electrode 61 is electrically coupled to the second wire in each second pair of wires. The second capacitive-sensing electrode 62 is electrically coupled to the second wire in each first pair of wires. Each pair of capacitive-sensing electrodes may correspond to a column of the grid. Each row consists at least two pairs of wires aligned horizontally and a capacitive-sensing electrode 60. The capacitive-sensing electrode 60 is electrically coupled to the first wire in each pair, within the row. When integrated into an electronic musical device, a musical control signal may be triggered when the user interacts with one of the conductive wires 63 electrically coupled to a vertical capacitive-sensing electrode 61 or 62 while interacting with one of the conductive wires 63 electrically coupled to a horizontal capacitive-sensing electrode 60. Interacting with various columns may allow for the user to vary the pitch or other configured sound parameter based on the column interacted with (e.g., based on which pair of capacitive-sensing electrodes 61 and 62 are interacted with). Interacting with the rows of the grid (e.g., interacting with the conductive wires 63 electrically coupled to capacitive-sensing electrode 60) may produce various notes or sounds altered by the sound parameter determined by an interaction with the columns of the grid (e.g., interaction with conductive wires 63 electrically coupled to capacitive-sensing electrode 61 or 62). The user may interact with multiple conductive wires 63 in each column corresponding to different rows of the grid at the same time or in quick succession to produce multiple musical sounds at one time. The user may additionally or alternatively interact with multiple columns of the grid to change the degree a produced musical sound is altered for each row of the grid. The capacitive-sensing electrodes 60-62 may sense the intensity and location of a user's finger in each row and column. This wire arrangement may be configured with a variety of functions such as a fret board or finger board of a sting instrument, various types of non-grid-based configurations, or a position slider interface controlling at least one sound parameter. This conductive wire arrangement may be used to create an ergonomic electronic version of a guitar, violin, or other instrument that utilizes fingerboards or fretboards providing the user with a music device with similar tactile markers as a traditional musical device.

When integrated into an electronic musical device, the wire arrangement depicted in FIG. 6 may utilize light-emitting diodes (LEDs) mounted to a printed circuit board (PCB) beneath the conductive wires 63 to indicate the arrangement of the wire configuration. The light-emitting diodes (LEDs) may be configured to highlight various functional configurations of the wire arrangement in FIG. 6. In some instances, the light-emitting diodes (LEDs) may be configured to highlight the musical scale notes or root notes in a particular configuration. The light-emitting diodes (LEDs) may additionally be configured to indicated drum or sequencer patterns. When the conductive wire arrangement is configured to act as a position slider interface, the light-emitting diodes may indicate the setting of the slider interface. This arrangement may additionally be extended or reduced by adding or removing wire pair rows or columns to fit the desired form factor of the chosen electronic musical device.

The specific arrangement utilized may be determined by each induvial electronic music device. There can be any combination of wire arrangements to provide a tactile interface for interacting with an electronic music device. An arrangement may be chosen from predetermined arrangements or can be determined specifically for the electronic musical device and the desired enclosure used. The various possible arrangements of the wire-based capacitive touch interface allow for the creation of portable, ergonomic, and accessible music devices without sacrificing the ability to be creative, expressive, nuanced, and intuitive when creating various musical sounds. The electronic musical device may be device that is handheld, portable, stationary, or desktop. Based on the intended use of an electronic musical device, the chosen wire arrangements may change. For example, an electronic musical device intended to be handheld and portable may utilize a compact wire arrangement to enhance portability and decrease overall size of the electronic musical device. In some embodiments, the electronic musical device may be intended to be stationary, and the chosen wire arrangement may be selected based on the enclosure rather than portability. In some embodiments, the electronic musical device is intended to mimic a tradition musical instrument or another musical device and may utilize a wire arrangement that mimics the interactions with the traditional musical instrument. A single electronic music device may utilize multiple wire arrangements designed to function collectively as different wire sets within the electronic musical device. An electronic musical device may include a capacitive wire-based input interface configured to be a multi-functional control interface and a processing circuit configured to interpret changes in capacitance across the input interface and generate musical control signals for the generation of musical sounds. The processing circuit may include a capacitive-sensing integrated circuit or microcontroller with capacitive sensing capabilities configured to generate control signals based on changed capacitance on the wires on the input interface. The processing circuit may additionally include a processor or processing component configured to generate musical control signals based on the control signals generated by the capacitive-sensing integrated circuit or microcontroller and the configured operations of the wires interacted with to generate the control signals. The multi-functional control interface provides multiple musical functions though interaction with the wires of the input interface. The multi-functional control interface may include two or more wire sets. The first wire set may be configured though a processing component to provide a variety of musical outputs, through interaction with the first wire set. The second wire set may be configured though a processing component to provide the ability to alter or change the configuration of the first wire set, allowing broad control of the musical outputs produced by interacting with the first wire set.

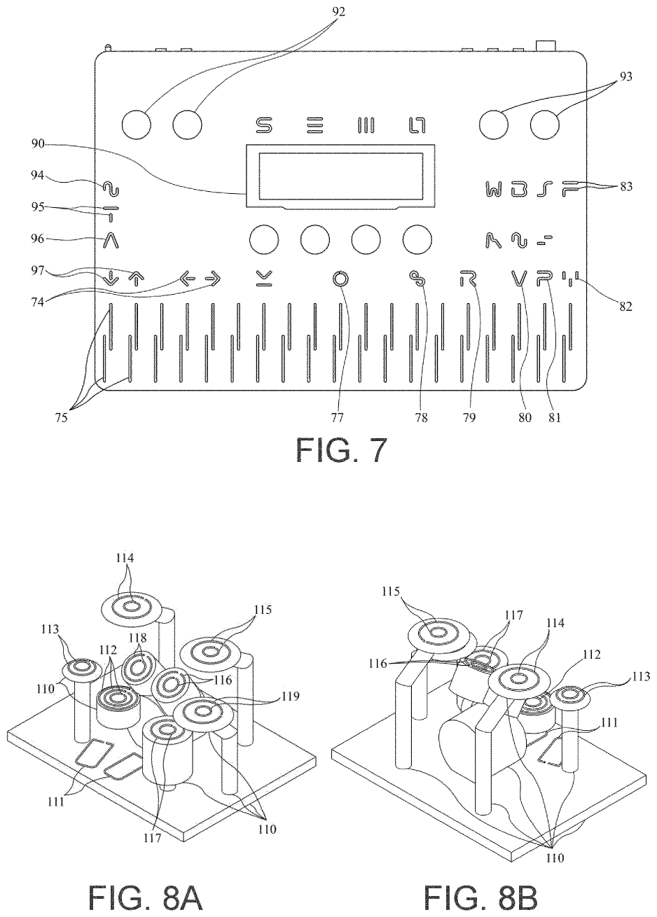

FIG. 7 depicts an electronic musical device that utilizes a capacitive wire-based input interface using multiple groupings and arrangements of conductive wires in combination with other control mechanisms. The electronic musical device includes two sets of conductive wires, a first set of conductive wires 75 arranged as a key type arrangement to play specific musical sounds through user interactions, and a second set of conductive wires containing various wire groupings and arrangements to control the configuration of the first set of conductive wires 75, such as various synthesis parameters, and recording and looping functions of generated audio. The electronic musical device may also include a display 90, which depicts various synthesis sound parameter menus. Conductive wires 94, 95, 96, and 97 may be configured to display various synthesis sound parameter menus on the display 90. The electronic musical device may include rotary encoders 92 and 93 to provide additional control to synthesis sound parameters, such as setting the sound parameters depicted on the display by conductive wires 94-96.

The first set of conductive wires 75 formed in the arrangement depicted in FIG. 4A to mimic the function of keys of a keyboard. The first set of conductive wires 75 can be configured in any of the configuration depicted in FIG. 4B. A user interaction with the first set of wires may cause the generation off musical sounds based on the configuration determined and the other synthesis parameters selected.

The second set of conductive wires includes an arrangement of conductive wires 97 shaped as up and down arrows. The conductive wires 97 formed as up and down arrows are configured to transpose the first set of conductive wires 75 by octave. The second set of conductive wires includes an arrangement of conductive wires 74 shaped as left and right arrows. The conductive wires 74 formed into left and right arrows are configured to transpose the notes associated with the conductive wires in the first set of conductive wires 75 by a scale degree. The conductive wire 77 formed into a circle is configured to control the recording process of the electronic musical device. The conductive wire 78 formed in the shape of a figure eight is configured to access the looping functions of the electronic musical device. The conductive wire 79 formed as a letter “R” is configured to activate or display the device's global reverb effect. The global reverb effect's depth and decay time parameters may be attenuated to the rotary encoders 93. The conductive wires 83 formed as a letter “F” may be configured to control the functionality of the rotary encoders 93. Interacting with the conductive wires 83 formed as an “F” may change the rotary encoders 93 to control sounds parameters of a filter effect rather than a reverb effect. The conductive wire 80 formed as a “V”, the conductive wire 81 formed as a “P”, and the group of conductive 82 wires formed as a single key are each used to control various sound parameters corresponding to the velocity, pressure, and y-axis position of a user touch or interaction with the key configuration of the first set of conductive wires 75. Each conductive wire is formed into a tactile shape to provide tactile accessibility to the control of the electronic musical device.

The electronic musical device may include a processing circuit. The processing circuit may be configured to interpret sensed capacitance from user interaction with the conductive wires and generated musical control signals based on the user interactions. The processing circuit may comprise at least one capacitive-sensing integrated circuit configured to determine various control signals based on capacitance sensed or capacitive signals from user interactions with the wire-based capacitive input interface. The at least one capacitive sensing-integrated circuit may transmit the control signal to a processor or processing component configured to generate musical control signals based on the received control signals and the programmed configurations for the musical device.

The electronic musical device may additionally include at least one light emitting diode (LED) positioned beneath a conductive wire and configured to provide the user with visual feedback on the configuration, operation, or interaction of the wire. The processing circuit may control the light-emitting diode (LED) to display the interpretation of capacitance measurements to the user. For example, the light-emitting diode (LED) may have varying brightness based on the sensed intensity of the user's interaction, such as greater pressure on the conductive wire may correspond to a greater intensity of emitted light from the light-emitting diode (LED) corresponding to the conductive wire. The light emitting diode (LED) may be configured to depict a setting of a parameter at various intensities such as when the first set of conductive wires 75 is configured to function as a fader, the light-emitting diode (LED) may signify the setting of the fader by emitting a higher intensity of light when the fader has a higher setting. The processing circuit may control the light-emitting diode (LED) to display whether a control function associated with a conductive wire is active. For example, the light-emitting diode (LED) may be turned on or off based on the activation of a function, such as recoding. The light-emitting diode (LED) may be on or blinking to signify distinct parts of the recording function, and off when the recording is not active or completed. A light emitting diode may additionally be configured to what wires are active or activated, such as a low intensity light being emitted when the corresponding conducive wire is active, a high intensity light emitted when the corresponding conducive wire is activated by user interaction, and no light emitted when the corresponding conducive wire is not active or off.

The electronic music device may additionally comprise a vibration actuator. The vibration actuator may be configured to provide haptic feedback to the user. The vibration actuator may be configured to provide the user information regarding a particular selected configuration or the specific wire the user is interacting with. For example, the vibration actuator may be configured to produce a specific vibration if the user is interacting with the wire corresponding to the recording function to signify that the electronic music device has begun recording synthesized sound. Additionally, or alternatively, the vibration actuator may be configured to utilize a specific vibration to communicate the configuration of first set of conductive wires 75 in the key type of arrangement, providing additional accessibility features and the ability for the user to continue creating music without needing to check what configuration the electronic music device is set to. The provided vibrations may also be correlated directly to a synthesis parameter correlated to a specific shaped wire or wire configuration, providing the user with information regarding a potential change in musical synthesis or information regarding the current function of the electronic musical device.

The electronic musical device may include a housing or enclosure to contain the components. The housing may include a surface containing at least one aperture through which conductive wires protrude. The housing may include an aperture for each conductive wire utilized the wire-based capacitive input interface. The housing may also include a mounting mechanism for a display or other non-wire-based components for the user to interact with. The conductive wires may be routed through an aperture in the enclosure and terminated to a printed circuit board (PCB) housed withing the enclosure. The printed circuit board (PCB) may be mounted within the enclosure, so that it is accessible to the conductive wires. The enclosure may be formed out of a transparent or translucent material to allow light from light emitting diodes to be visible to the user outside the enclosure.

When implementing a wire-based capacitive touch interface in an electronic music device, the processing circuit may have limited capacitive sensing inputs, limiting the number of wire-based capacitive interfaces implemented in an electronic music device. It may be desirable when determining which wire-based capacitive interfaces to implement, to consider what is necessary for the to provide the desired accessibility and/or ability to create intuitive and expressive musical sounds. When capacitive inputs are limited and electronic music device may additionally implement conventional control inputs such as rotary encoders, sliders, or buttons to provide additional versatility. The electronic music device of FIG. 7 implements rotary encoders 92 and 93 for additional versatility. The rotary encoders 92 and 93 may be used to change the function of the wire-based capacitive interface arrangements and sound parameters providing more versatility to the electronic music device, without using more of the limited capacitive-sensing inputs.

Utilizing a wire-based capacitive input interface provides opportunities to implement capacitive interfaces into a variety of two-dimensional and three-dimensional shapes. A conductive wire terminated to a capacitive-sensing electrode may be formed into a two-dimensional or three-dimensional shape and extended through a complex enclosure. The versatility of a wire based capacitive input interface allows for the creation of complex electronic music devices, not typically possible with traditional electronic components.

A complex electronic music device utilizing a multi-wire capacitive wire interface is depicted in FIG. 8A-B. The electronic music device comprises a complex enclosure 110 that depicts an electronic version of a drum kit and sets of conductive wires 111-119 terminated to capacitive-sensing electrodes within the enclosure. Each set of conductive wire 111-119 may correspond to a specific part of the drum set, and produces musical sounds based on the configured drums. For example, the electronic music device could be configured to represent a version of a standard drum kit containing a bass drum, snare drum, tom-tom, floor tom, crash cymbal, high-hat, splash cymbal, and ride cymbal. Wire set 111 may be configured to function as the petals used to play a bass drum or a Hi-hat cymbal. When interacted with, the user's position, pressure, and speed would be used to determine the sounds generated based on the instrument the wire set is configured to function as. Sensing the speed, location, and pressure of the interaction provides the ability for different user interactions to generate different sounds corresponding closer to the sound expected from a traditional drum set. Wire set 112 may be configured to function as a snare drum. The snare drum configuration may be with or without the snare, providing versatility in the sound synthesized. Wire set 112 may have the ability to sense the speed, location, and pressure of user interactions, allowing a variety of musical sounds to be produce. Wire set 113 may be configured to function as a hi-hat cymbal. The hi-hat may be played with a wire set 111 representing the corresponding foot petal. The hi-hat may additionally or alternatively be played using the wire set 113 configured to the cymbal potion of the hi-hat. User interaction with the wire set 113 configured to act as the cymbal portion of a hi-hat can vary the generated sound by the electronic music device through determining the speed, location, and pressure of the interactions with the wire set. Wire set 114 may be configured to function as a crash cymbal. Wire set 115 may be configured to function as a ride cymbal. Wire set 116 and wire set 118 can be configured to function as a tom-tom where wire set 116 may be configured to function as a middle tom drum, and wire set 118 may be configured to function as a high tom drum. Wire set 117 may be configured to function as a floor tom drum. Wire set 119 may be configured to function as a splash cymbal. Each wire set 111-119 has the capability to sense the pressure, speed, and location of user interactions, allowing for the generation of a variety of musical sounds correlating to the instruments in the drum set, and providing an electronic music device that provides similar musical sounds to a traditional drum set. The electronic music device may additionally or alternatively be configured to include additional drums, cymbals, and other percussion instruments.

The electronic music device further comprises a processing circuit to determine the specific drum sounds synthesized based on user interaction with the wire-based capacitive interface. The processing circuit may utilize sensed capacitance to determine location, speed, and pressure to determine which musical sound to generate. The electronic music device may be configured with a variety of types of drum sets, providing a variety of options to the user. Additionally, or alternatively, the electronic music device may be configured to allow user selection of the drum set desired or select an instrument for a particular wire set 111-119, providing more versatility to the user. For example, a user may choose they want a jazz drum kit or a rock drum kit. Additionally, or alternatively, the user may select the specific instrument they want to play or change an instrument type from a drum kit, for example a user may select a standard drum kit and configure wire set 113 to a cowbell instead of a Hi-hat.

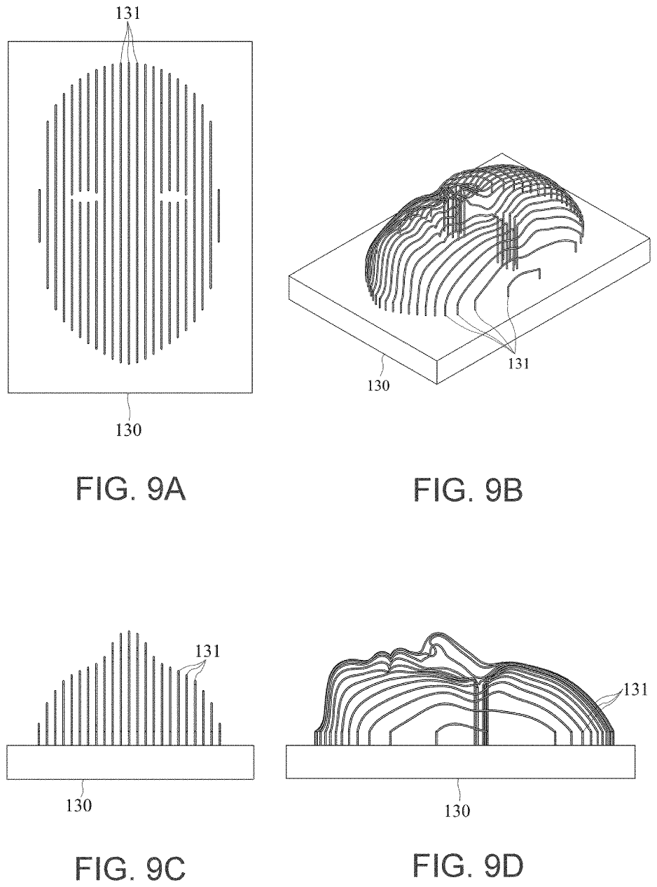

A multi-wire capacitive wire interface can additionally or alternatively be formed to reflect an organic shape or complex three-dimensional shape. FIG. 9A-D depict various views of an electronic music device utilizing a wire-based capacitive input interface with the wires formed into an ergonomic contour of a three-dimensional shape of a face. The electronic music device comprises an enclosure 130 housing a processing circuit electrically coupled to capacitive-sensing electrodes mounted to a printed circuit board (PCB) and formed conductive wires 131 exposed on the surface of the enclosure 130 and terminated to the printed circuit board (PCB) such that each wire is electronically coupled to a capacitive-sensing electrode, forming the wire-base capacitive input interface. The conductive wires 131 are formed and organized on the surface of the enclosure 130 to form the three-dimensional shape of a face.

Each wire is electrically coupled to a capacitive-sensing electrode providing the ability to sense the location of a user's interaction anywhere on the three-dimensional wire-based capacitive sensing electrode. The user may be capable of interacting with the wires at any location to produce a variety of sounds based on the measured capacitance corresponding to the interaction. The three-dimensional organic shape of the wire-based capacitive interface provides the user with the ability to control the music device with a variety of free form interactions, providing creative sound production. The processing circuit may be configured to produce a variety of vocal sounds based on the location, pressure, and speed of an interaction. The wire used to create a wire-based capacitive input interface may be formed into a variety of shapes to provide inspiration to the user, and the processing circuit of a corresponding music device may be configured to produce a variety of musical sounds.

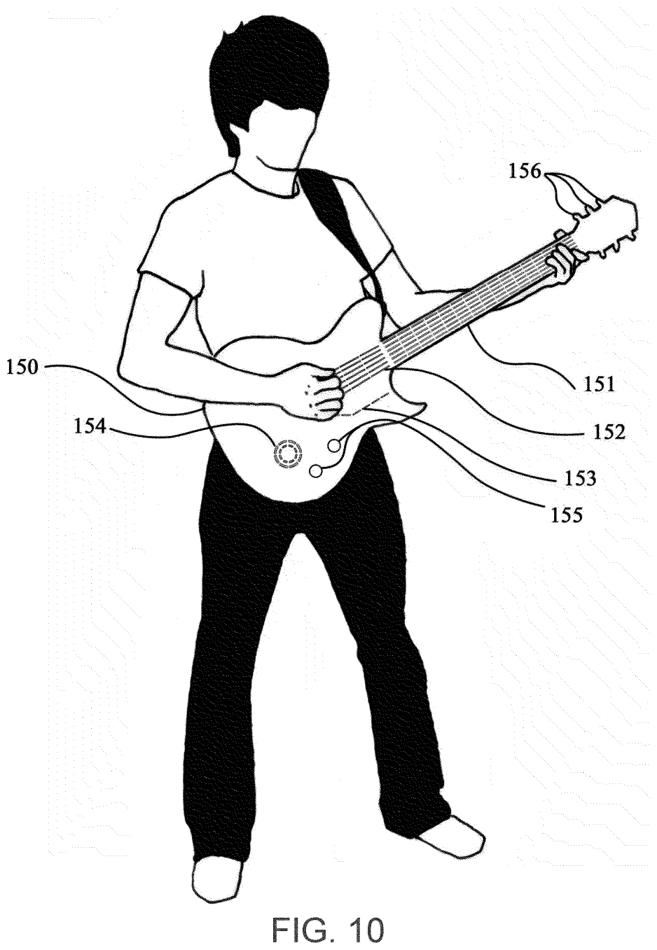

Now referring to FIG. 10, an electronic musical device 150 in the shape of a guitar using the capacitive wire arrangement depicted in FIG. 6 is depicted. The electronic musical device 150 may be a portable synthesizer or sequencer device that mimics a guitar with variable synthesizing parameters. In some embodiments, the electronic musical device 150 includes an enclosure or housing shaped as a guitar containing interface components for the device and a processing circuit to interpret interactions with interface components. The interface components may include an arrangement of a wire-based capacitive input interface in the arrangement depicted in FIG. 6 as guitar fretboard 151. The fretboard 151 may include six rows of paired conductive wires 152, wherein an interaction with the conductive wires in a row of paired conductive wires 152 may be interpreted as strings of a guitar. In some embodiments, releasing a conductive wire in a row of paired conductive wires 152 may be interpreted as a variable velocity note based on a sensed change of capacitance, a grater capacitance change may result in a greater note velocity triggered. A user may interact with the fretboard 151 by using a plucking motion on various rows of paired conductive wires 152 while making contact with various locations on the conductive wires in a row of paired conductive wires 152 to generate various note timbres. The interface components of the electronic musical device 150 may additionally include a capacitive input interface 135 including a set of capacitive wires arranged as a “whammy” bar of a guitar. The capacitive input interface 153 may be configured with various synthesis parameters (e.g., pitch bend or vibrato, etc.), selectable through user interaction with specific wire locations on the capacitive input interface 153. In some embodiments, the interface components include a capacitive input interface 154 with two sets of independent capacitive wires arranged into an outer and inner circle. The first set of capacitive wires may be arranged as the outer circle and the second set of capacitive wire may be arranged as the inner circle of the capacitive input interface 154. The outer circle of the capacitive input interface 154 may be configured to cycle through various synthesizer presets. The inner circle of the capacitive input interface 154 may be configured to select different pages or sets of the synthesizer presets corresponding to the outer circle. In some embodiments, the interface components of the electronic musical device 150 include two push button rotary encoders 155 and six rotary encoders 156. The one push button rotary encoder 155 may be configured to control the volume of the sound generated by the electronic musical device. The other push button rotary encoder 155 may be configured to control any mappable synthesizer parameter. The six rotary encoders 156 may be installed on the neck of the guitar shaped enclosure of the electronic musical device 150, positioned to face outward. The six rotary encoders 156 may be configured to function as guitar tuners, through altering pitch of the six rows of paired conductive wires 152 on the fretboard 151 interface. The six rotary encoders 156 may each correspond to a different row of paired conductive wires 152 and may individually control the pitch of the sound corresponding to a row of paired conductive wires 152. The electronic musical device 150 may include light-emitting diodes (LEDs). Light-emitting diodes (LEDs) may be included under the capacitive wires of fretboard 151, capacitive input interface 133, or capacitive input interface 154. The light-emitting diodes (LEDs) may be used to provide visual feedback of various parameters or controls of the electronic musical device to assist the user with navigating the device.

In some embodiments, the electronic musical devices utilizing wire-based capacitive input interfaces such as those depicted in FIG. 7, FIG. 8A-B, FIG. 9A-D, and FIG. 10 include a speaker or interface component to connect the electronic musical device to an external device (e.g., speaker, amplifier, or headset, etc.). The processing circuit may the musical control signals to an internal speaker or interface component to generate or produce a musical sound based on the musical control signals. In some embodiments, the electronic musical devices may include an interface component to connect the electronic musical device to a video game console. The processing circuit may be configured to communicate specific musical control signals through the interface component to the gaming console to provide a means to interact with a video game through the electronic musical device utilizing wire-based capacitive input interfaces.

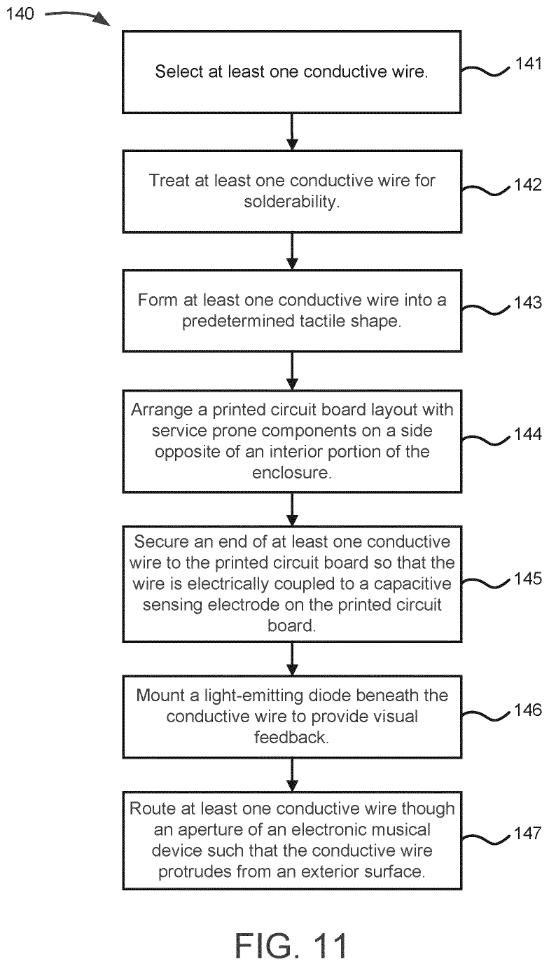

Now referring to FIG. 11, a method 140 for making an electronic musical device using a wire-based capacitive input interface is shown. The method 140 may include selecting at least one conductive wire 141. In some embodiments, the conductive wire is selected from a corrosion resistant material such as aluminum or stainless steel. In some embodiments, the method 140 includes treating the conductive wire for solderability 142. The method 140 may include, forming the conductive wire into a predetermined tactile shape 143. The tactile formed shape of the conductive wire may be two-dimensional or three-dimensional. When forming the conductive wire, hand tools may be used. In some embodiments, the conductive wire is formed using automated wire bending equipment. The automated wire-bending equipment may be set to a particular two-dimensional or three-dimensional tactile shape. The method 140 may include securing the conductive wire to a printed circuit board (PCB) so that the wire is electrically coupled to a capacitive-sensing electrode on the printed circuit board (PCB) 145. In some embodiments, the method includes arranging the layout of the printed circuit board (PCB) with service-prone components on as side opposite of an interior portion of the enclosure 144. Arranging the layout of the printed circuit board (PCB) with service-prone components on a side opposite of an interior position of the enclosure 144 may facilitate repair. In some embodiments, the method 140 includes mounting a light-emitting diode beneath the conductive wire to provide visual feedback 146. The method 140 may include routing the conductive wire though an aperture of an electronic musical device such that the conductive wire protrudes from an exterior surface 147.

The arrangement, construction, and description of the systems and methods as shown in the various examples are illustrative only. While some examples have been described herein, several modifications and/or adjustments are possible (e.g., variations in sizes, dimensions, structures, shapes, and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions, and arrangement of the embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

As used herein, an element or step recited in the singular and proceeded with the word “a” or “an” should be understood as not excluding plural elements or steps, unless such exclusion is explicitly recited. Furthermore, references to “exemplary embodiment,” “example embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed as means-plus-function elements (e.g., under 35 U.S.C. §112(f)) unless “means for” or “step for” is expressly recited in the claim(s).

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art may recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, or “at least one of A, B, or C” is used, in both cases such usage should be interpreted as covering any permutation of A, B, or C, alone or in combination, unless expressly indicated otherwise (e.g., “a system having at least one of A, B, and C” would include systems that have A alone, B alone, C alone, A and B together, A and C together, B and C together, and A, B, and C together). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.” Further, the use of the words “approximate,” “about,” “around,” “substantially,” etc., may mean plus or minus ten percent, in some implementations.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. An input interface for an electronic musical device, the input interface comprising:
a printed circuit board comprising at least one capacitive sensing electrode; and
a conductive wire formed into a raised tactile shape and mounted to the printed circuit board, the conductive wire electrically coupled to the at least one capacitive sensing electrode;
wherein the conductive wire is configured to function as a capacitive input element for detecting user touch and providing tactile feedback.

2. The input interface of claim 1, wherein the conductive wire is shaped into a symbol, character, or ergonomic contour corresponding to a musical function.

3. The input interface of claim 1, wherein the conductive wire protrudes through an aperture in an enclosure of the electronic musical device to provide tactile accessibility.

4. The input interface of claim 1, further comprising a light-emitting diode (LED) mounted beneath the conductive wire to provide visual feedback.

5. The input interface of claim 1, further comprising of a plurality of conductive wires electrically coupled to a plurality of electrodes;
wherein the plurality of conductive wires form a multi-functional control interface;
wherein the multi-functional control interface comprises a plurality of musical functions corresponding to the raised tactile shape of the plurality of conductive wires.

6. The input interface of claim 1, wherein the printed circuit board further comprises at least one capacitive sensing integrated circuit electrically coupled to the at least one capacitive sensing electrode.

7. An electronic musical device comprising:
a housing;
an input interface comprising:
a printed circuit board comprising at least one electrode; and
a conductive wire formed into a raised tactile shape and mounted to the printed circuit board, the conductive wire electrically coupled to the at least one electrode;
wherein the conductive wire is configured to function as a capacitive input element for detecting user touch and providing tactile feedback; and
a processing circuit electrically coupled to the input interface, configured to interpret capacitive signals from the conductive wire and generate musical control signals responsive to user interaction.

8. The electronic musical device of claim 7, wherein the processing circuit is configured to map capacitive input to musical parameters including note velocity, pitch bend, or filter modulation.

9. The electronic musical device of claim 7, wherein the housing includes multiple apertures through which respective conductive wires protrude, each wire shaped to indicate a distinct musical function.

10. The electronic musical device of claim 7, further comprising a vibration actuator configured to provide haptic feedback correlated to a synthesis parameter.

11. The electronic musical device of claim 7, wherein the processing circuit comprises:
at least one capacitive sensing integrated circuit configured to determine control signals based on sensed capacitance from a user interaction with the input interface; and
a processor electrically coupled to the at least one capacitive sensing integrated circuit, configured to generate musical control signals based on control signals;
wherein the at least one capacitive sensing integrated circuit transmits control signals to the processor.

12. The electronic musical device of claim 7, wherein the processing circuit is configured to determine a location and intensity of a user interaction with the input interface and generate a plurality of musical control signals;
wherein the plurality of musical control signals vary based on the location and intensity of the user interaction with the input interface.

13. The electronic musical device of claim 7, wherein the input interface further comprises a plurality of conductive wires electrically coupled to a plurality of electrodes;
wherein the plurality of conductive wires form a multi-functional control interface;
wherein the multi-functional control interface comprises a plurality of musical functions corresponding to the raised tactile shape of the plurality of conductive wires.

14. The electronic musical device of claim 13, wherein the multi-functional control interface further comprises:
a first plurality of conductive wires configured to mimic a function of keys of a keyboard; and
a second plurality of conductive wires configured to provide control to the function of the first plurality of conductive wires.

15. The electronic musical device of claim 14, wherein the first plurality of conductive wires musically functions as keys on the keyboard; and
the second plurality of conductive wires changes the function of the first plurality of conductive wires from a first set of keys of the keyboard to a second set of keys of the keyboard.

16. A method comprising:
forming a conductive wire into a predetermined tactile shape;
securing at least one end of the conductive wire to a printed circuit board (PCB) such that the conductive wire is electrically coupled to a capacitive sensing electrode; and
routing the conductive wire through an aperture in an enclosure of an electronic musical device such that the conductive wire protrudes from an exterior surface of the enclosure.

17. The method of claim 16, further comprising:
mounting a light-emitting diode (LED) beneath the conductive wire to provide visual feedback.

18. The method of claim 16, further comprising:
shaping the conductive wire using automated wire-bending equipment into a two-dimensional or three-dimensional form.

19. The method of claim 16, further comprising:
selecting the conductive wire from stainless steel or aluminum and treating the conductive wire to be solderable.

20. The method of claim 16, further comprising:
arranging a printed circuit board layout to position service-prone components on a side opposite of an interior portion of the enclosure to facilitate repair.
